(19) United States
(12) Patent Application Publication
(10) Pub. No.: US 2013/0267312 A1
(43) Pub. Date: Oct. 10, 2013

(54) ORDERED LOADING OF WAGERING GAME ASSETS INTO MEMORY

(71) Applicant: WMS GAMING, INC., Waukegan, IL (US)

(72) Inventors: John L. Walsh, Gurnee, IL (US); Damon E. Gura, Chicago, IL (US); Jorge L. Shimabukuro, Las Vegas, NV (US); Craig J. Sylla, Round Lake, IL (US)

(73) Assignee: WMS GAMING, INC., Waukegan, IL (US)

(21) Appl. No.: 13/787,353

(22) Filed: Mar. 6, 2013

Related U.S. Application Data
(60) Provisional application No. 61/621,215, filed on Apr. 6, 2012.

(51) Int. Cl. A63F 13/12

(52) U.S. Cl. CPC A63F 13/12
USPC 463/31; 463/43; 463/40

(57) ABSTRACT

A method includes determining a load order for loading game assets into a cache memory of a wagering game machine, wherein the game assets comprise data used for presentation of a wagering game at the wagering game machine. The game assets are accessible by a processor in the wagering game machine from the cache memory for presentation of the wagering game, wherein the load order is based on wagering game activity at the wagering game machine. The method includes loading the game assets into the cache memory based on the load order. The method includes accessing, by a processor in the wagering game machine, the game assets from the cache memory. The method also includes presenting, on at least one display device, the wagering game based on the game assets.

### RELATED APPLICATIONS

This application claims the priority benefit of U.S. Provisional Application Ser. No. 61/621,215 filed Apr. 6, 2012.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2013, WMS Gaming, Inc.

### FIELD

Embodiments of the inventive subject matter relate generally to wagering game systems, and more particularly to wagering game systems including ordered loading of game assets into memory for wagering games.

### BACKGROUND

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for wagering game machine manufacturers to continuously develop new games and gaming enhancements that will attract frequent play.

### BRIEF DESCRIPTION OF THE FIGURES

Embodiments of the invention are illustrated in the Figures of the accompanying drawings in which:

FIG. 1 depicts a wagering game system for loading in a load order game assets into a cache memory of a wagering game machine for wagering game access, according to some example embodiments.

FIGS. 2-3 depict examples of a default load order configuration file, according to some example embodiments.

FIG. 4 depicts a flowchart for loading and unloading of game assets into a cache memory of a wagering game machine for wagering game access, according to some example embodiments.

FIG. 5 depicts a block diagram illustrating a wagering game machine architecture, according to some example embodiments.

FIG. 6 depicts a block diagram illustrating a wagering game network, according to some example embodiments.

FIG. 7 depicts a perspective view of a wagering game machine, according to some example embodiments.

FIG. 8 depicts an image of a base-game screen for a wagering game machine, according to some example embodiments.

### DESCRIPTION OF THE EMBODIMENTS

This description of the embodiments is divided into six sections. The first section provides an introduction to some example embodiments, while the second section provides system environments. The third section describes example operations performed by some example embodiments. The fourth section describes an example wagering game machine architecture and network environment. The fifth section describes an example wagering game machine and the sixth section presents some general comments.

### Introduction

This section provides an introduction to some example embodiments. Some example embodiments are applicable to both online wagering game play and wagering game play at brick-and-mortar wagering game establishments using a wagering game machine. Some example embodiments are used in a multi-game environment, wherein a wagering game player can play different wagering games at a same machine. As used herein, a wagering game machine can include any machine for presenting wagering games at a brick-and-mortar wagering game establishment, online wagering game play, etc.

The resources in a wagering game machine are typically finite. For example, the size of volatile machine-readable medium (e.g. cache memory) that is typically loaded with the game assets that are accessed by a processor to cause presentation of a wagering game is limited. As described herein, this volatile machine-readable medium is referred to as cache memory but is defined to include any type of volatile machine-readable media that is accessed by the processor to cause presentation of a wagering game (e.g., Random Access Memory (RAM), Dynamic RAM (DRAM), cache, etc.). The bandwidth for loading the game assets either over a network or from a nonvolatile machine readable medium (e.g., FLASH memory) is also limited. Accordingly, because of cache memory and/or load time constraints, some example embodiments provide various caching mechanisms to minimize pauses in game play due to the assets having to be loaded from the network or other low bandwidth storage device.

In some example embodiments, the load order of game assets into cache memory is based on various criteria related to the wagering game, the play of the wagering game, the identification of the wagering game player, the location of the wagering game machine, etc. Events in the wagering games are typically predictable and often occur in patterns. For example, the odds of hitting a “big win” is statistically very low, so it's assets would be placed near the end of the load order. Additionally, game assets that are larger in size (e.g., texture data, audio data, visual data, etc.) can be loaded into the cache memory dynamically. In some example embodiments, probability determinations of game asset being accessed during wagering game play are determined. The load order of the game assets into cache memory can be determined based on these probability determinations. For example, math tables used to determine probability of wins can be used to predict the load order of the game assets. Based on the math tables, there can be different categories of wins (e.g., low paying, high frequency wins, medium paying wins, and high paying low frequency wins). Games assets used for these different wins (e.g., video, audio, etc.) can be loaded into cache memory based on these categories. For example, the low paying high frequency wins are loaded before the medium paying wins, which are loaded before the high paying low frequency wins.

In some example embodiments, the load order of game assets into cache memory is based the identification of the wagering game player that is playing at the machine. For example, the game assets of the wagering game that the wagering game player typically plays are loaded into cache memory after the identification of the player is determined. To illustrate, assume that wagering game player A typically (e.g., more than 50%) plays wagering game Z. After wagering game player A logs into the machine, the game assets for wagering game Z are loaded into cache memory. In another example, the game assets of the wagering game that the wagering game player most recently played is loaded into cache memory after the identification of the player is determined.

In some example embodiments, the cache memory can be unloaded of certain game assets based on different criteria. For example, if the player has played a certain bonus game that they will not play for an extended period (e.g., at least 500 spins), the game assets for this bonus game can be unloaded from the cache memory. Similar, if the play has played a certain episode of an episodic game that they will not likely play again, the game assets for this episode can be unloaded from the cache memory.

### System Environment

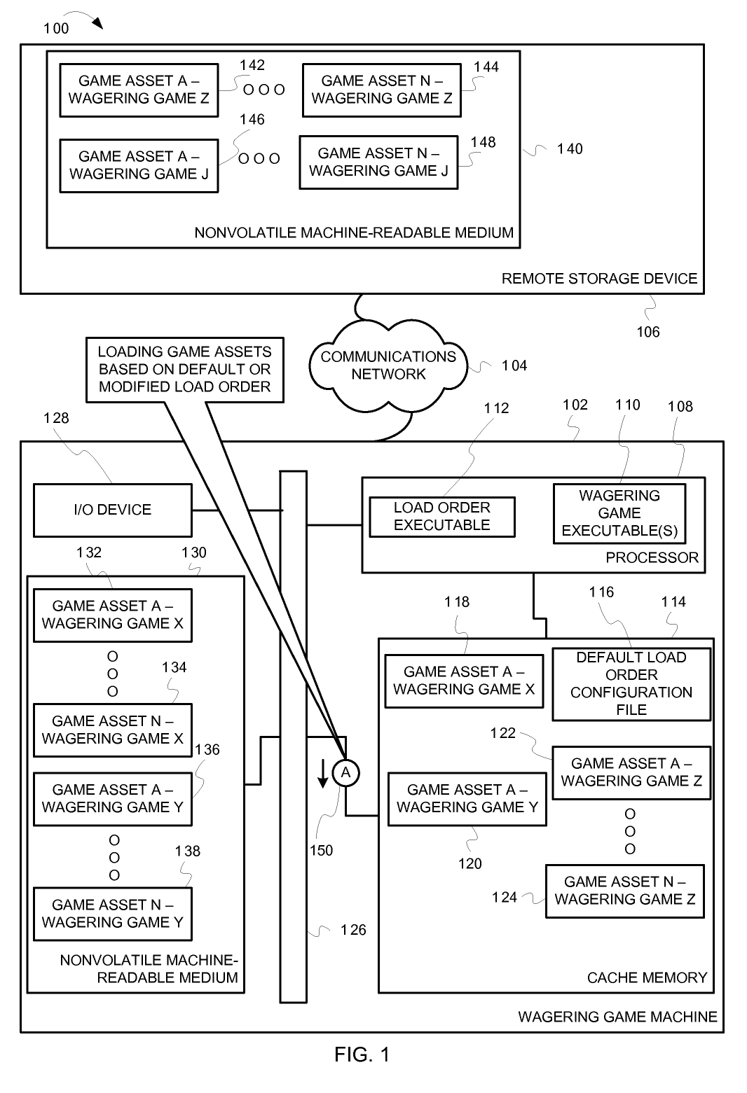

FIG. 1 depicts a wagering game system for loading in a load order game assets into a cache memory of a wagering game machine for wagering game access, according to some example embodiments. A wagering game system 100 depicts a configuration, wherein a wagering game executable that is executed in a processor of a wagering game machine access different game assets from a cache memory. A cache memory can represent any type of volatile machine-readable medium that is accessed by a processor during execution of a wagering game executable to present a wagering game.

The game assets can be loaded from a nonvolatile machine-readable medium that is local or remote to the wagering game machine. Also, the order for loading the game assets can be based on a default load order that is determined prior to play of the wagering game. This default load order can be modified. For example, as further described below, this default load order can be modified after an identification of the wagering game player is determined, after plays by the wagering game player, etc. The default and modified load order can be based on a number of different criteria. As further described below, the criteria can be based on an identification of the wagering game player, the particular wagering game, the location of the wagering game machine, the play by the wagering game player, the play by other wagering game players at other wagering game machines, etc. Also, the wagering game machine can be configured to enable play of any number of different wagering games.

The wagering game system 100 includes a wagering game machine 102 and a remote storage device 106 that are communicatively coupled together over a communications network 104. The wagering game machine 102 can be a wagering game machine at a brick-and-mortar wagering game establishment, a computer providing online wagering game play, etc. The remote storage device 106 can be a server that can be either internal or external to the wagering game establishment. For example, the remote storage device 106 can be a wagering game server within a wagering game establishment. The communications network 104 can be a Local Area Network, the Internet, etc.

The wagering game machine 102 includes a processor 108, a cache memory 114, a nonvolatile machine-readable medium 130, an Input/Output (I/O) device 128, and a communications bus 126. The processor 108, the I/O device 128, the nonvolatile machine-readable medium 130, and the cache memory 114 are communicatively coupled together through the communications bus 126. In this example, the processor is also directly coupled to the cache memory 114.

In this example, the processor 108 has already been loaded for execution on a load order executable 112 and wagering game executable(s) 110. The load order executable 112 and wagering game executable(s) 110 can be software instructions that are executed by the processor 108. The load order executable 112 is configured to load the game assets for different wagering games into the cache memory 114. The load order executable 112 can load the game assets according to a default load order that is defined in a default load order configuration file 116. The load order executable 112 can also modify this default load order based on a number of different criteria (e.g., identification of the wagering game player), as further described below. Also, the wagering game executable(s) that use these game assets can override the order to retrieve any game asset on demand. Each of the wagering game executable(s) 110 can represent a different wagering game. During execution in the processor 108, the wagering game executable(s) 110 retrieve game assets that are stored in the cache memory 114 in order to present the wagering game. The game assets can include texture data, audio data, visual data, etc.

The cache memory 114 is shown to have data therein that can be received from different nonvolatile machine-readable media. In this example, based on execution of the load order executable 112, the data is stored in the cache memory 114 from the different nonvolatile machine-readable media, according to the order provided by the default load order configuration file 116.

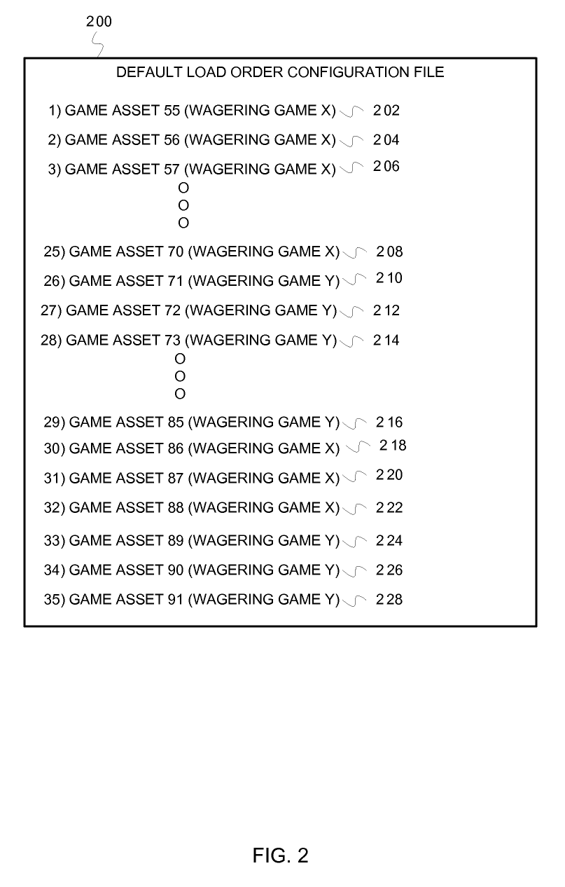

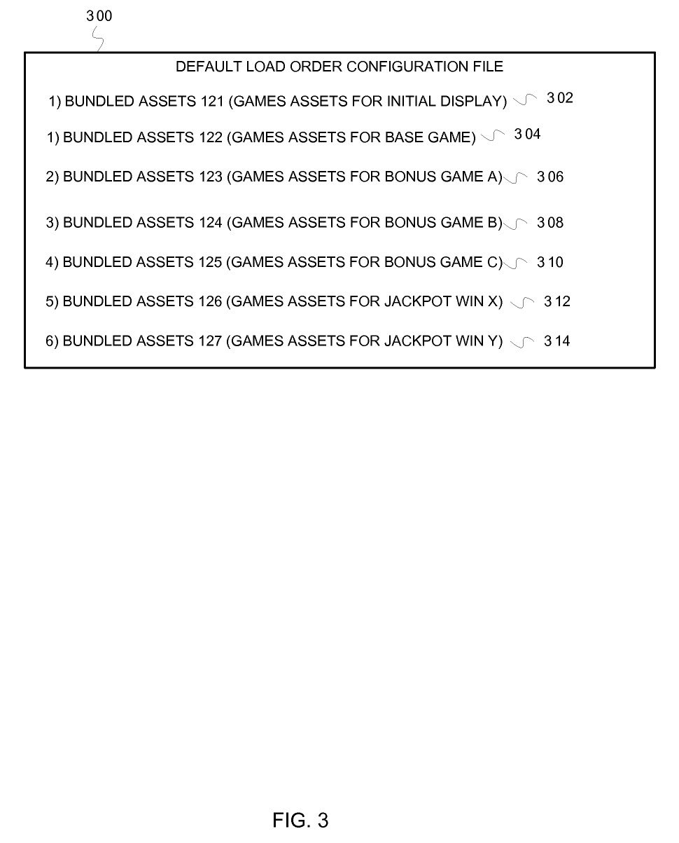

The cache memory 114 includes the default load order configuration file 116 and a number of different game assets for different wagering games. Examples of the default load order configuration file 116 are depicted in FIGS. 2-3, which are further described below. In this example, the cache memory 114 has been loaded with a game asset A for wagering game X 118, a game asset A for wagering game Y 120, and the game assets for wagering game Z (game assets A-N) 122-124. Accordingly, in this example, a partial load of game assets are loaded for the wagering game X and wagering game Y and full load of game assets are loaded for the wagering game Z.

The nonvolatile machine-readable medium 130 is shown to store different game assets for different wagering games. In this example, the nonvolatile machine-readable medium 130 stores the game assets for wagering game X (game assets A-N) 132-134 and the game assets for wagering game Y (game assets A-N) 136-138.

The remote storage device 106 also includes a nonvolatile machine-readable medium (a nonvolatile machine-readable medium 140) that stores games assets that can be retrieved for storage in the cache memory 114 over the communications network 104. In this example, the nonvolatile machine-readable medium 140 stores the game assets for wagering game Z (game assets A-N) 142-144 and the game assets for wagering game J (game assets A-N) 146-148. FIG. 1 also depicts a communication 150 being received for storage in the cache memory 114. The communication 150 can be the loading of different game assets for different wagering games from either or both local or remote machine-readable media (e.g., the nonvolatile machine-readable medium 130, the nonvolatile machine-readable medium 140, etc.).

Game assets can include texture data, audio data, and visual data accessed by game executables for presenting multimedia (visuals, audio, etc.) as part of presenting the wagering game (e.g., base game, bonus game, etc.). Game assets can also include the game executables themselves. A game asset can be within three different storage categories based on its storage location. A first storage category is inactive remote, wherein a game asset is stored at a remote location (e.g., a wagering game server that is communicatively coupled to the wagering game machine). In this example, the game assets in the nonvolatile machine-readable medium 140 in the remote storage device 106 are considered inactive remote and as such are not at a location for active access for wagering game play. A second storage category is inactive resident, wherein a game asset is stored in a machine-readable medium in the wagering game machine that is not the cache memory that is accessed by a processor to cause presentation of a wagering game. In this example, the game assets in the nonvolatile machine-readable medium 130 in the wagering game machine 102 are considered inactive resident. A third storage category is active resident, wherein a game asset is stored in the cache memory that is accessed by a processor to cause presentation of a wagering game. Because the cache memory that is accessed for execution is limited, only a limited number of wagering games can be active resident on the wagering game machine. In this example, the game assets in the cache memory 114 in the wagering game machine 102 are considered active resident.

In some example embodiments, the load order of game assets into the cache memory 114 is based on various criteria related to the wagering game, the play of the wagering game, the identification of the wagering game player, the location of the wagering game machine, etc. The load order can be defined within the default load order configuration file 116 and can be varied during operations of the wagering game machine based on these different criteria or on-demand requests for particular game assets.

Events in the wagering games are typically predictable and often occur in patterns. For example, the odds of hitting a “big win” is statistically very low, so it's assets would be placed near the end of the load order. Additionally, game assets that are larger in size (e.g., texture data, audio data, visual data, etc.) can be loaded into the cache memory dynamically. In some example embodiments, probability determinations of a game asset being accessed during wagering game play are determined. The load order of the game assets into the cache memory 114 can be determined based on these probability determinations. For example, math tables used to determine probability of wins can be used to predict the load order of the game assets. Based on the math tables, there can be different categories of wins (e.g., low paying, high frequency wins, medium paying wins, and high paying low frequency wins). Games assets used for these different wins (e.g., video, audio, etc.) can be loaded into the cache memory 114 based on these categories. For example, the low paying high frequency wins are loaded before the medium paying wins, which are loaded before the high paying low frequency wins.

In some example embodiments, the load order of game assets into the cache memory 114 is based on the relationships (e.g., dependency) among the game assets. For example, if game asset B is accessed after game asset A has been accessed by the processor, the game asset B is loaded (if not already) into the cache memory 114 after the game asset A has been accessed.

In some example embodiments, the load order of game assets into the cache memory 114 is based the identification of the wagering game player that is playing at the machine. For example, the game assets of the wagering game that the wagering game player typically plays are loaded into the cache memory 114 after the identification of the player is determined. To illustrate, assume that wagering game player A typically (e.g., more than 50%) plays wagering game Z. After wagering game player A logs into the machine, the game assets for wagering game Z are loaded into the cache memory 114. In another example, the game assets of the wagering game that the wagering game player most recently played is loaded into the cache memory 114 after the identification of the player is determined. In another example, the load order is based on the identification of the player relative to the day of week, time of day, etc., and the identification of the wagering game establishment, and the identification of the wagering game machine and its location. For example, assume that the wagering game player B generally plays wagering game X on weekends and wagering game Y during the week. Accordingly, the game assets for the particular game are loaded into the cache memory 114 after the identification of the player is determined and in accordance with the day of the week.

In some example embodiments, the load order of game assets into the cache memory 114 are across multiple wagering games. In particular, a partial group of game assets for multiple wagering games are loaded before the completing loading of game assets for a particular wagering game. For example, game assets for the base game of two different wagering games are loaded prior to loading the other parts (e.g., game assets for the bonus games) of the two wagering games. This load order can occur for a particular wagering game player if they typically switch between the base game for two different wagering games frequently.

Some wagering games are configured to enable a wagering game player to select parts of the game to play. For example, the wagering game player may be able to select which bonus games to play in a bonus round. In some example embodiments, the load order of game assets into the cache memory 114 is based on the most likely selectable parts of the game by the wagering game player. For example, assume that the wagering game player generally selects bonus game A among a number of bonus games. The game assets for the bonus game A can be loaded into the cache memory 114 prior to loading the game assets for the other bonus games.

In some example embodiments, the load order of game assets into the cache memory 114 is based on likely behaviors of groups of wagering game players. For example, the load order of game assets into the cache memory 114 can be based on the behaviors of wagering game players at a particular wagering game establishment, a particular bank of wagering game machines, etc. For example, assume that among a defined group of wagering game players, these wagering game players will most likely select bonus game G among a number of bonus games in a bonus round. The game assets for the bonus game G can be loaded into the cache memory 114 prior to loading the game assets for the other bonus games for a wagering game player that is considered a part of the defined group of wagering game players.

These different wagering behaviors of a particular wagering game player or groups of wagering game players can be retrieved from a wagering game server (e.g., the remote storage device 106) over the communications network 104. For example, after a wagering game player has logged into their account at the wagering game machine 102, a player profile regarding this player is downloaded from the wagering game player to assist in the load order into the cache memory 114. In particular, this player profile can cause the load order executable to modify the load order defined in the default load order configuration file 116.

In some example embodiments, the load order of game assets into the cache memory 114 is not defined relative to a specific wagering game player but is defined relative to anonymous behavior of one or more wagering game players. To illustrate, the load order of game assets into the cache memory 114 can be based day of the week, time of day, etc. relative to anonymous behavior of a group of wagering game players. For example, assume that a defined group of wagering game players (e.g., those in a particular wagering game establishment) typically plays wagering game M on the weekends at a particular wagering game establishment, a particular bank of wagering game machines, etc. The game assets for the wager game M can be loaded into the cache memory 114 prior to loading the game assets for the other wagering games.

Also, the load order can be overridden based on actual demand during wagering game play. For example, assume that the load order sets a particular bonus game to be loaded at the end of the load order but that the bonus game is triggered during play of the base game. In response, the load order is overridden to load the bonus game in response to its trigger.

In some example embodiments, the load order of game assets into the cache memory 114 is based on the likelihood of entering a bonus game. In particular, the bonus games with a higher probability of occurring are loaded into the cache memory 114 prior to the other bonus games.

Wagering game players can also set up player accounts for online play of casual (non-wagering) games that are related to the wagering games. For example, there can be casual games and wagering games that share a same theme. The play of these casual games can enable the player to accumulate player points, unlock bonus games or other content, etc. for the wagering game. In some example embodiments, the load order of game assets into the cache memory 114 is based on the play of these casual games. For example, if the player has unlocked a particular bonus game for a wagering game as part of the casual games, this particular bonus game is loaded prior to other bonus games.

In some example embodiments, the load order of game assets into the cache memory 114 for online wagering games is based on game play for wagering games at a wagering game establishment or vice versa. For example, assume that a same type of wagering game (e.g., a wagering game with theme A) is played by a wagering game player through both online wagering game play and game play at a wagering game establishment. Also, assume that the wagering game player has been playing the wagering game with theme A through online play. In response to the player logging into a wagering game machine at a wagering game establishment wherein different wagering games can be played therein, the game assets for the wagering game with theme A is loaded prior to game assets for other wagering games.

In some example embodiments, the game assets are bundled based on their being accessed together or near in time. An example of game asset bundling for a base game of a slot machine can include the reel symbols, audio associated, and win animations. An example of game asset bundling for a bonus game for a slot machine can include the particular animations and audio for the particular bonus. These bundled game assets can then be loaded together into the cache memory 114 cache memory 114. An example of such bundling for the default load order configuration file 116 is depicted in FIG. 3, which is described in more detail below. The determination of this bundling of game assets can be determined prior to release of the wagering game and/or dynamically after the wagering game has been released for play. Accordingly, the bundling of the game assets can change over time based on statistics gathered during play of the wagering game. Some game assets can be part of multiple bundles. Accordingly, some example embodiments determine if a game asset has been previously loaded as part of a prior bundle. If the game asset has already been loaded, the game asset is not loaded again even though it is a part of a current bundle being loaded into the cache memory 114 cache memory 114.

In some example embodiments, some game assets would have such a large footprint in the cache memory 114 and have a low probability of occurring that these assets are denoted to only be loaded on demand. Examples of such game assets can include the video animations associated with a large jackpot win.

In some example embodiments, there is a default load order of game assets into the cache memory 114 for a particular wagering game, a particular wagering game machine having a group of wagering games, etc.—as shown by the default load order configuration file 116. This default order can be determined prior to release of the wagering game. To illustrate, developers of the wagering game can make this determination. In another example, this default order can be determined based on the location of the machine. In some example embodiments, the default load order of game assets into the cache memory 114 can be changed dynamically after the wagering game has been played. This change in the default order can be based on any of a number of different criteria (as described herein) (e.g., identification of the wagering game player).

In some example embodiments, the load order of game assets into the cache memory 114 is based on the typical wagering behavior for the particular wagering game player. For example, if the player typically plays the wagering game such that they are never eligible for or select a particular bonus game or event, the game assets for this particular bonus game or event can be placed at the back end of the load order. In some example embodiments, the load order of game assets into the cache memory 114 is based on the actual wagering behavior for the particular wagering game player. For example, assume the player has to perform such actions in the wagering game prior to being eligible for a particular event and that those actions have not yet occurred. To illustrate, the wagering game can be a type of collection game wherein certain parts of the game are unlocked based on a collection of certain outcomes in the game (e.g., certain reel symbols had to be shown in a result of a reel spin). In some example embodiments, unless the player has unlocked or is close to unlocking the event, the game assets for this particular event can be placed at the back end of the load order. Accordingly, these game assets can move up in the load order dynamically if the event has been or is close to being unlocked.

In some example embodiments, the cache memory 114 can be unloaded of certain game assets based on different criteria. For example, if the player has played a certain bonus game that they will not play for an extended period (e.g., at least 500 spins), the game assets for this bonus game can be unloaded from the cache memory 114. Similar, if the play has played a certain episode of an episodic game that they will not likely play again, the game assets for this episode can be unloaded from the cache memory 114.

Some wagering games are configured such that certain content cannot be played unless multiple wagering game players are playing a same wagering game together at different machines. In these situations, the load order of game assets into the cache memory 114 can be based on whether multiple wagering game players are playing the same wagering game. If not, the game assets for this particular content can be placed at the back end of the load order. Some wagering games are community-based games that include multiple wagering game players, wherein the actions of one of the players can affect the play of the other players. For example, actions by one of the players can result in the unlocking of certain content (e.g., a bonus game) to the exclusion of other content for the play of the other players. In these situations, the load order of game assets into the cache memory 114 can be based the actions of the other players in the community-based game—moving the unlocked content to the top of the load order based on the actions of one of the players. Also in these situations, the unload order of the game assets from the cache memory 114 can be based the actions of the other players in the community-based game—removing content from the cache memory 114 cache memory 114 that has been excluded based on the actions of the one of the players.

In some example embodiments, the load order executable 112 can determine and/or modify load order based on a trend analysis that uses inferential statistics (e.g., correlation, regression, etc.) as described in U.S. Published Patent Application No. 20040166940A1, filed on Feb. 26, 2003 (inventor: Wayne H. Rothschild), which is hereby incorporated by reference.

FIGS. 2-3 depict examples of a default load order configuration file, according to some example embodiments. FIG. 2 depicts a default loader order configuration file 200 which is an example of the default load order configuration file 116. In this example and in contrast to the example in FIG. 3 (described in more detail below), the game assets are not bundled together. The default load order configuration file 200 is configured such that the first game asset to be loaded into cache memory is at the top and the last game asset to be loaded into cache memory is at the bottom (at least for those assets listed). In this example, there are load instructions for two different wagering games (wagering game X and wagering game Y). Also for this example, there is a partial loading of game assets for wagering game X and wagering game Y. In particular, there is a loading of some of the game assets for wagering game X, followed by some of the game assets for wagering game Y, followed by some additional game assets for wagering game X, followed by some additional game assets for wagering game Y. For example, the first group of game assets for wagering game X can be for a base game of wagering game X; the first group of game assets for wagering game Y can be for a base game of wagering game Y; the next group of game assets for wagering game X can be for bonus games for wagering game X; and the next group of game assets for wagering game Y can be for bonus games for wagering game Y.

First, there are instructions 202-208 for game assets 55-70 for wagering game X, respectively. Next, there are instructions 210-216 for game assets 71-85 for wagering game Y, respectively. Next, there are instructions 218-222 for game assets 86-88 for wagering game X. Next, there are instructions 224-228 for game assets 89-91 for wagering game Y.

FIG. 3 is now described. FIG. 3 depicts a default loader order configuration file 300 which is another example of the default load order configuration file 116. In this example and in contrast to the example in FIG. 2, the game assets are bundled together. The game assets can be bundled based on their being accessed together or near in time. An example of game asset bundling for a base game of a slot machine can include the reel symbols, audio associated, and win animations. An example of game asset bundling for a bonus game for a slot machine can include the particular animations and audio for the particular bonus.

In this example, there are game assets for different parts of one wagering game. The default load order configuration file 300 is configured such that the first bundled game assets to be loaded into cache memory are at the top and the last bundled game assets to be loaded into cache memory are at the bottom (at least for those assets listed).

A first instruction 302 is for loading the different game assets for the initial display for the wagering game machine—bundled assets 121. A second instruction 304 is for loading the different game assets for the base game for the wagering game—bundled assets 122. A third instruction 306 is for loading the different game assets for the bonus game A for the wagering game—bundled assets 123. A fourth instruction 308 is for loading the different game assets for the bonus game B for the wagering game—bundled assets 124. A fourth instruction 310 is for loading the different game assets for the bonus game C for the wagering game—bundled assets 125. A fifth instruction 312 is for loading the different game assets for the jackpot win X for the wagering game—bundled assets 126. A sixth instruction 314 is for loading the different game assets for the jackpot win Y for the wagering game—bundled assets 127. While only showing the bundled assets for one wagering game, the default loader order configuration file 300 can include bundled assets for multiple wagering games—similar to the default loader order configuration file 200 of FIG. 2.

### Example Operations

This section describes operations associated with some example embodiments. In the discussion below, the flow chart will be described with reference to the block diagrams presented above. However, in some example embodiments, the operations can be performed by logic not described in the block diagrams.

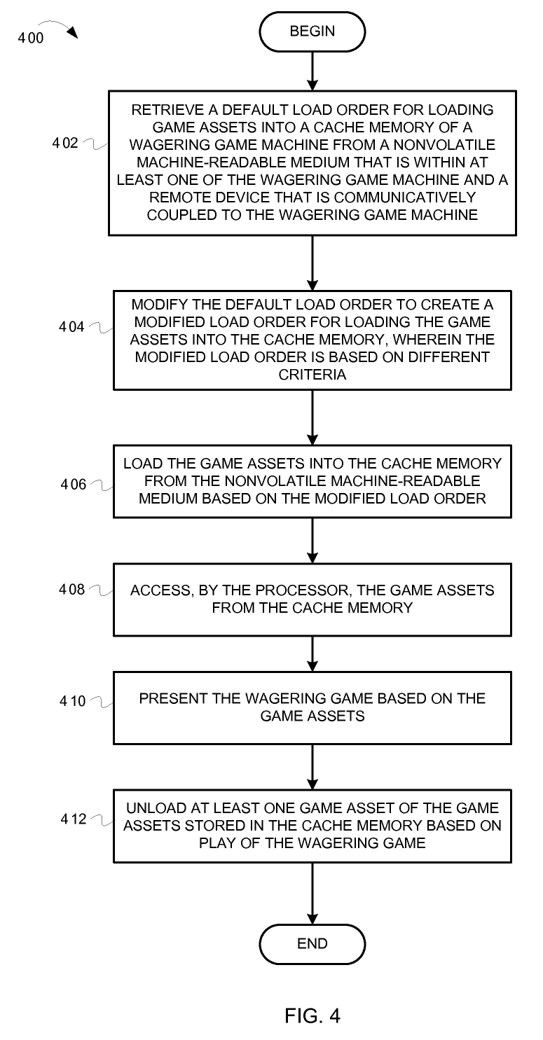

In certain embodiments, the operations can be performed by executing instructions residing on machine-readable media (e.g., software), while in other embodiments, the operations can be performed by hardware and/or other logic (e.g., firmware). In some embodiments, the operations can be performed in series, while in other embodiments, one or more of the operations can be performed in parallel. Moreover, some embodiments can perform less than all the operations shown in the flowchart. The section will discuss FIG. 4.

FIG. 4 depicts a flowchart for loading and unloading of game assets into a cache memory of a wagering game machine for wagering game access, according to some example embodiments. The operations of a flowchart 4000 are described in reference to FIG. 1. In some example embodiments, the operations are performed by the load order executable 112 and the wagering game executable(s) 110 of the wagering game system 100 of FIG. 1. The operations of the flowchart 4000 begin at block 402.

At block 402, the load order executable retrieves a default load order for loading game assets into a cache memory of a wagering game machine from a nonvolatile machine-readable medium that is within at least one of the wagering game machine and a remote device that is communicatively coupled to the wagering game machine. With reference to FIG. 1, the load order executable 112 retrieves the default load order from the default load order configuration file 116 in the cache memory 114. Operations of the flowchart 400 continue at block 404.

At block 404, the load order executable modifies the default load order to create a modified load order for loading the game assets into the cache memory, wherein the modified load order is based on different criteria. With reference to FIG. 1, the load order executable 112 may or may not modify this default load order. As described above, this default load order can be modified at any time after the default load order is defined. For example as described above, the load order executable 112 can modify this default load order after the player logs in a player account at the wagering game machine. The load order executable 112 can then modify based on the identification of the player. Operations of the flowchart 400 continue at block 406.

At block 406, the load order executable loads the game assets into the cache memory from the nonvolatile machine-readable medium based on the modified load order. With reference to FIG. 1, the load order executable 112 loads the game assets into the cache memory 114 from either or both of the nonvolatile machine-readable medium 130 in the wagering game machine 102 or the nonvolatile machine-readable medium 140 in the remote storage device 106 over the communications network 104. Operations of the flowchart 400 continue at block 408.

At block 408, the wagering game executable(s) access the game assets from the cache memory. With reference to FIG. 1, the wagering game executable(s) 110 is executed by the processor 108 thereby causing the wagering game executable(s) 110 to retrieve different game assets from the cache memory 114 during execution. As described above, the wagering game executable(s) 110 can retrieve a game asset on demand that is not in the cache memory 114—thereby overriding the load order is necessary. Operations of the flowchart 400 continue at block 410.

At block 410, the wagering game executable(s) presents the wagering game based on the game assets. With reference to FIG. 1, the wagering game executable(s) 110 may present wagering games, such as video poker, video black jack, video slots, video lottery, etc., in whole or part. For example, the wagering game executable(s) 110 can output video, audio, etc. related to reel spins, reel spin results, jackpot wins, etc. Operations of the flowchart 400 continue at block 412.

At block 412, the load order executable unloads at least one game asset of the game assets stored in the cache memory based on play of the wagering game. With reference to FIG. 1 in some configurations, the load order executable 112 can unload some game assets from the cache memory based on the different criteria (described above). For example, if the player has played a certain bonus game that they will not play for an extended period (e.g., at least 500 spins), the load order executable 112 can unload the game assets for this bonus game from the cache memory 114. Operations of the flowchart 400 are complete.

### Wagering Game Machine Architecture and Network Environment

This section describes an example wagering game architecture and network environment of some example embodiments.

### Wagering Game Machine Architecture

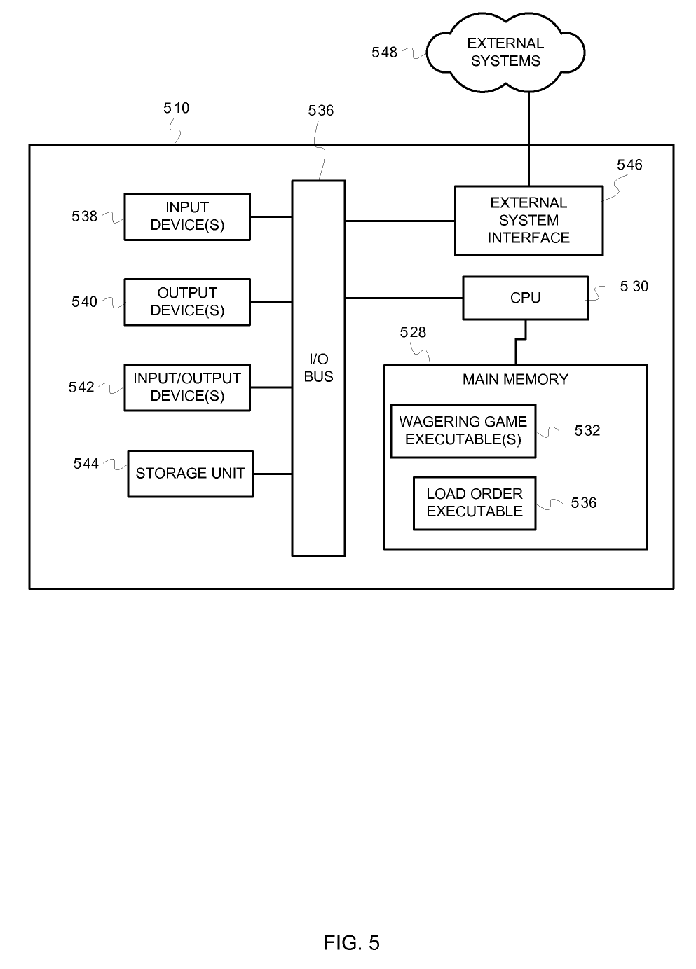

FIG. 5 depicts a block diagram illustrating a wagering game machine architecture, according to some example embodiments. In particular, FIG. 5 depicts an architecture of the wagering game machine 102 of FIG. 1. The gaming terminal 510 includes a central processing unit (CPU) 530 connected to a main memory 532. The CPU 530 may include any suitable processor(s), such as those made by Intel and AMD. By way of example, the CPU 530 includes a plurality of microprocessors including a master processor, a slave processor, and a secondary or parallel processor. CPU 530, as used herein, comprises any combination of hardware, software, or firmware disposed in or outside of the gaming terminal 510 that is configured to communicate with or control the transfer of data between the gaming terminal 510 and a bus, another computer, processor, device, service, or network. The CPU 530 comprises one or more controllers or processors and such one or more controllers or processors need not be disposed proximal to one another and may be located in different devices or in different locations. The CPU 530 is operable to execute all of the various gaming methods and other processes disclosed herein. The main memory 528 includes wagering game executable(s) 532 and load order executable 536. In one embodiment, the wagering game executable(s) 532 may present wagering games, such as video poker, video black jack, video slots, video lottery, etc., in whole or part. In some example embodiments, the load order executable 536 performs the operations for loading and unloading of game assets for wagering games (as described above).

The CPU 530 is also connected to an input/output (I/O) bus 536, which can include any suitable bus technologies, such as an AGTL+ frontside bus and a PCI backside bus. The I/O bus 536 is connected to various input devices 538, output devices 540, and input/output devices 542 such as those discussed below in connection with FIG. 15. The I/O bus 536 is also connected to storage unit 544 and external system interface 46, which is connected to external system(s) 548 (e.g., wagering game networks).

The external system 548 includes, in various aspects, a gaming network, other gaming terminals, a gaming server, a remote controller, communications hardware, or a variety of other interfaced systems or components, in any combination. In yet other aspects, the external system 548 may comprise a player's portable electronic device (e.g., cellular phone, electronic wallet, etc.) and the external system interface 546 is configured to facilitate wireless communication and data transfer between the portable electronic device and the CPU 530, such as by a near-field communication path operating via magnetic-field induction or a frequency-hopping spread spectrum RF signals (e.g., Bluetooth, etc.).

The gaming terminal 510 optionally communicates with the external system 48 such that the terminal operates as a thin, thick, or intermediate client. In general, a wagering game includes an RNG for generating a random number, game logic for determining the outcome based on the randomly generated number, and game assets (e.g., art, sound, etc.) for presenting the determined outcome to a player in an audio-visual manner. The RNG, game logic, and game assets are contained within the gaming terminal 10 (“thick client” gaming terminal), the external system 548 (“thin client” gaming terminal), or are distributed therebetween in any suitable manner (“intermediate client” gaming terminal).

The gaming terminal 510 may include additional peripheral devices or more than one of each component shown in FIG. 15. Any component of the gaming terminal architecture may include hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic disk storage media, optical storage media, flash memory, etc.

### Wagering Game Network

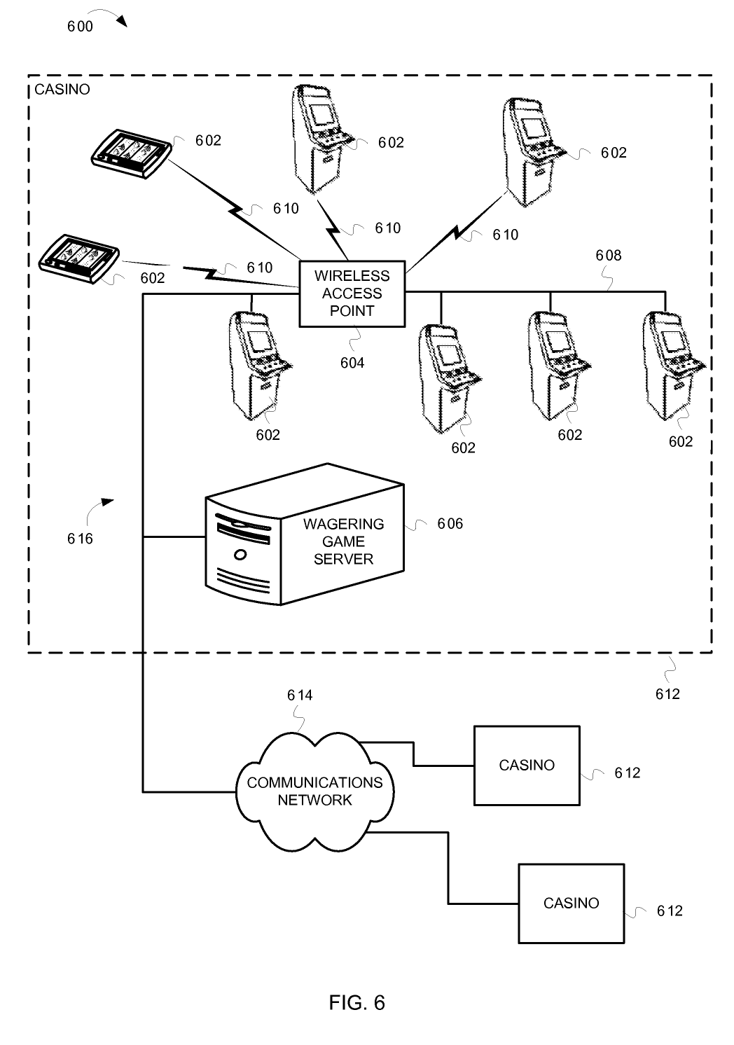

FIG. 6 depicts a block diagram illustrating a wagering game network, according to some example embodiments. As shown in FIG. 6, the wagering game network 600 includes a plurality of casinos 612 connected to a communications network 614.

Each casino 612 includes a local area network 616, which includes an access point 604, a wagering game server 606, and wagering game machines 602. The access point 604 provides wireless communication links 610 and wired communication links 608. The wired and wireless communication links can employ any suitable connection technology, such as Bluetooth, 802.11, Ethernet, public switched telephone networks, SONET, etc. In some embodiments, the wagering game server 606 can serve wagering games and distribute content to devices located in other casinos 612 or at other locations on the communications network 614.

The wagering game machines 602 described herein can take any suitable form, such as floor standing models, handheld mobile units, bartop models, workstation-type console models, etc. Further, the wagering game machines 602 can be primarily dedicated for use in conducting wagering games, or can include non-dedicated devices, such as mobile phones, personal digital assistants, personal computers, etc. In one embodiment, the wagering game network 600 can include other network devices, such as accounting servers, wide area progressive servers, player tracking servers, and/or other devices suitable for use in connection with embodiments of the invention.

In some embodiments, wagering game machines 602 and wagering game servers 606 work together such that a wagering game machine 602 can be operated as a thin, thick, or intermediate client. For example, one or more elements of game play may be controlled by the wagering game machine 602 (client) or the wagering game server 606 (server). Game play elements can include executable game code, lookup tables, configuration files, game outcome, audio or visual representations of the game, game assets or the like. In a thin-client example, the wagering game server 606 can perform functions such as determining game outcome or managing assets, while the wagering game machine 602 can present a graphical representation of such outcome or asset modification to the user (e.g., player). In a thick-client example, the wagering game machines 602 can determine game outcomes and communicate the outcomes to the wagering game server 606 for recording or managing a player's account. In some example embodiments, the wagering game machines 602 can have handheld image overlay devices and can be part of communal event (as described above).

In some embodiments, either the wagering game machines 602 (client) or the wagering game server 606 can provide functionality that is not directly related to game play. For example, account transactions and account rules may be managed centrally (e.g., by the wagering game server 606) or locally (e.g., by the wagering game machine 602). Other functionality not directly related to game play may include power management, presentation of advertising, software or firmware updates, system quality or security checks, etc.

Any of the wagering game network components (e.g., the wagering game machines 602) can include hardware and machine-readable media including instructions for performing the operations described herein.

### Example Wagering Game Machine

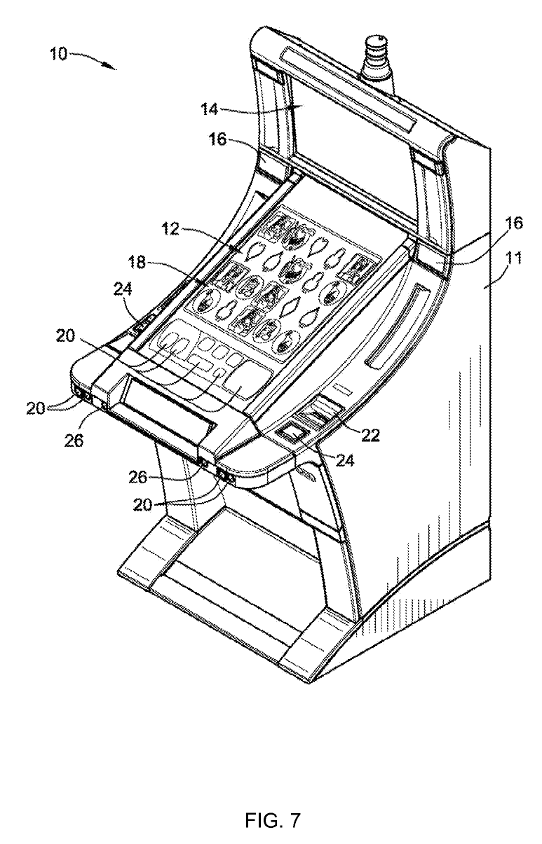

FIG. 7 depicts a perspective view of a wagering game machine, according to some example embodiments. Referring to FIG. 7, there is shown a gaming terminal 10 similar to those used in gaming establishments, such as casinos. With regard to the present invention, the gaming terminal 10 may be any type of gaming terminal and may have varying structures and methods of operation. For example, in some aspects, the gaming terminal 10 is an electromechanical gaming terminal configured to play mechanical slots, whereas in other aspects, the gaming terminal is an electronic gaming terminal configured to play a video casino game, such as slots, keno, poker, blackjack, roulette, craps, etc. The gaming terminal 10 may take any suitable form, such as floor-standing models as shown, handheld mobile units, bartop models, workstation-type console models, etc. Further, the gaming terminal 10 may be primarily dedicated for use in conducting wagering games, or may include non-dedicated devices, such as mobile phones, personal digital assistants, personal computers, etc. Exemplary types of gaming terminals are disclosed in U.S. Pat. No. 6,517,433 and Patent Application Publication Nos. US2010/0062196 and US2010/0234099, which are incorporated herein by reference in their entireties.

The gaming terminal 10 illustrated in FIG. 7 comprises a cabinet 11 that may house various input devices, output devices, and input/output devices. By way of example, the gaming terminal 10 includes a primary display area 12, a secondary display area 14, and one or more audio speakers 16. The primary display area 12 or the secondary display area 14 may be a mechanical-reel display, a video display, or a combination thereof in which a transmissive video display is disposed in front of the mechanical-reel display to portray a video image superimposed upon the mechanical-reel display. The display areas may variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming terminal 10. The gaming terminal 10 includes a touch screen(s) 18 mounted over the primary or secondary areas, buttons 20 on a button panel, bill validator 22, information reader/writer(s) 24, and player-accessible port(s) 26 (e.g., audio output jack for headphones, video headset jack, USB port, wireless transmitter/receiver, etc.). It should be understood that numerous other peripheral devices and other elements exist and are readily utilizable in any number of combinations to create various forms of a gaming terminal in accord with the present concepts.

Input devices, such as the touch screen 18, buttons 20, a mouse, a joystick, a gesture-sensing device, a voice-recognition device, and a virtual input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a CPU for processing. The electronic data signals are selected from a group consisting essentially of an electrical current, an electrical voltage, an electrical charge, an optical signal, an optical element, a magnetic signal, and a magnetic element.

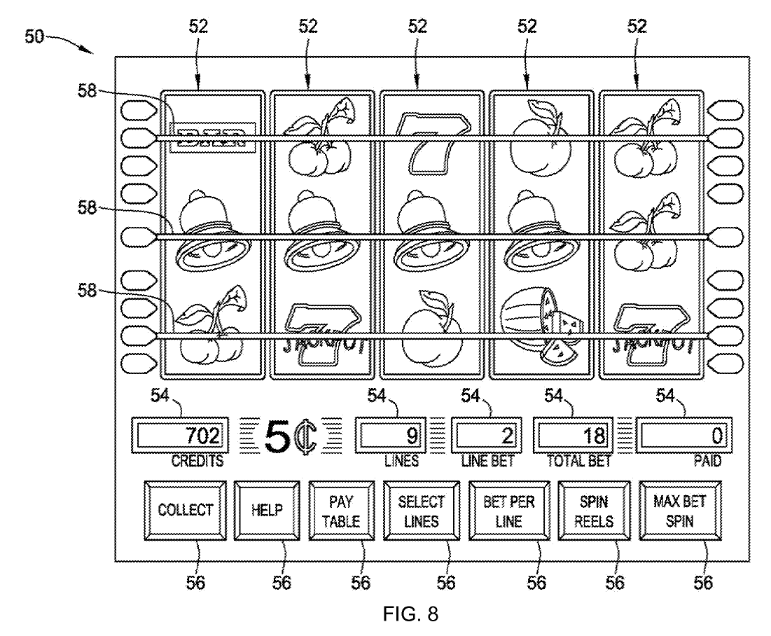

FIG. 8 depicts an image of a base-game screen for a wagering game machine, according to some example embodiments. Referring to FIG. 8, there is illustrated an image of a basic-game screen 50 adapted to be displayed on the primary display area 12 or the secondary display area 14. The basic-game screen 50 portrays a plurality of simulated symbol-bearing reels 52. Alternatively or additionally, the basic-game screen 50 portrays a plurality of mechanical reels or other video or mechanical presentation consistent with the game format and theme. The basic-game screen 50 also advantageously displays one or more game-session credit meters 54 and various touch screen buttons 56 adapted to be actuated by a player. A player can operate or interact with the wagering game using these touch screen buttons or other input devices such as the buttons 20. The CPU operate(s) to execute a wagering game program causing the primary display area 12 or the secondary display area 14 to display the wagering game.

In response to receiving a wager, the reels 52 are rotated and stopped to place symbols on the reels in visual association with paylines such as paylines 58. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering game outcome is provided or displayed in response to the wager being received or detected. The wagering game outcome is then revealed to the player in due course following initiation of the wagering game. The method comprises the acts of conducting the wagering game using a gaming apparatus, such as the gaming terminal 10, following receipt of an input from the player to initiate the wagering game. The gaming terminal 10 then communicates the wagering game outcome to the player via one or more output devices (e.g., primary display 12 or secondary display 14) through the display of information such as, but not limited to, text, graphics, static images, moving images, etc., or any combination thereof. In accord with the method of conducting the wagering game, the CPU transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the CPU is configured to process the electronic data signal, to interpret the data signal (e.g., data signals corresponding to a wager input), and to cause further actions associated with the interpretation of the signal in accord with computer instructions relating to such further actions executed by the controller. As one example, the CPU causes the recording of a digital representation of the wager in one or more storage media, the CPU, in accord with associated computer instructions, causing the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM), etc. The noted second state of the data storage media comprises storage in the storage media of data representing the electronic data signal from the CPU (e.g., the wager in the present example). As another example, the CPU further, in accord with the execution of the instructions relating to the wagering game, causes the primary display, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of computer instructions relating to the wagering game is further conducted in accord with a random outcome (e.g., determined by a RNG) that is used by the CPU to determine the outcome of the game sequence, using a game logic for determining the outcome based on the randomly generated number. In at least some aspects, the CPU is configured to determine an outcome of the game sequence at least partially in response to the random parameter.

### General

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims. Each of the embodiments described herein are contemplated as falling within the inventive subject matter, which is set forth in the following claims.

1. A method comprising:
determining a load order for loading game assets into a cache memory of a wagering game machine, wherein the game assets comprise data used for presentation of a wagering game at the wagering game machine, the game assets accessible by a processor in the wagering game machine from the cache memory for presentation of the wagering game, wherein the load order is based on wagering game activity at the wagering game machine;
loading the game assets into the cache memory based on the load order;
accessing, by a processor in the wagering game machine, the game assets from the cache memory; and
presenting, on at least one display device, the wagering game based on the game assets.

2. The method of claim 1, wherein the wagering game activity comprises at least one of probability of wins from play of the wagering game and an identification of a wagering game player playing the wagering game.

3. The method of claim 1, wherein the load order is based on play by the wagering game player of an online nonwagering game having a same theme as a theme of the wagering game.

4. The method of claim 3, wherein a game asset of the game assets is loaded into the cache memory before the other game assets, wherein the game asset is used for presenting content in the wagering game that has been unlocked by the wagering game player during play of the online nonwagering game.

5. The method of claim 1, wherein the load order is based on a history of play of the wagering game by a defined group of wagering game players relative to a time for a location of the wagering game machine.

6. The method of claim 1, wherein the load order is based on a probability of activating a bonus game of the wagering game.

7. A method comprising:
retrieving a default load order for loading game assets into a cache memory of a wagering game machine from a nonvolatile machine-readable medium that is within at least one of the wagering game machine and a remote device that is communicatively coupled to the wagering game machine, wherein the game assets comprise data accessed for presentation of a wagering game at the wagering game machine, wherein the game assets are accessed by a processor in the wagering game machine from the cache memory for presentation of the wagering game;
modifying the default load order to create a modified load order for loading the game assets into the cache memory, wherein the modified load order is based on an identification of a wagering game player playing the wagering game;
loading the game assets into the cache memory from the nonvolatile machine-readable medium based on the modified load order;
accessing, by the processor, the game assets from the cache memory;
presenting, on at least one display device, the wagering game based on the game assets; and
unloading at least one game asset of the game assets stored in the cache memory based on play of the wagering game, wherein the at least one game asset unloaded was accessed for display of a part of the wagering game that has already been played by the wagering game player.

8. The method of claim 7, wherein a different game asset is only loaded on demand into the cache memory in response to the different game asset exceeding a size threshold and in response to a probability of the different game asset being accessed by the process being below an access threshold.

9. The method of claim 7, wherein a multiple of game assets of the game assets are bundled together for being loaded into the cache memory, wherein the multiple of game assets are bundled based on being accessed by the processor at or near a same time.

10. The method of claim 7, wherein the load order is base on a history of play of the wagering game by the wagering game player, wherein a game asset for presenting content of the wagering game that has a probability that is below a threshold for being presented based on the history of play of the wagering game by the wagering game player is at least one of
loaded only on demand into the cache memory; and
positioned at an end of the load order.

11. The method of claim 7, wherein the wagering game comprises a community game that includes play by other wagering game players at other wagering game machines, wherein the load order is based on play by the other wagering game players.

12. One or more machine-readable storage media including instructions which, when executed by one or more processors, cause the one or more processors to perform operations comprising:
determine a load order for loading game assets into a cache memory of a wagering game machine, wherein the game assets comprise data used for presentation of a wagering game at the wagering game machine, the game assets accessible by a processor in the wagering game machine from the cache memory for presentation of the wagering game, wherein the load order is based on wagering game activity at the wagering game machine;
load the game assets into the cache memory based on the load order;
access, by a processor in the wagering game machine, the game assets from the cache memory; and
present the wagering game based on the game assets.

13. The one or more machine-readable storage media of claim 12, wherein the wagering game activity comprises at least one of probability of wins from play of the wagering game and an identification of a wagering game player playing the wagering game.

14. The one or more machine-readable storage media of claim 13, wherein the load order is based on play by the wagering game player of an online nonwagering game having a same theme as a theme of the wagering game.

15. The one or more machine-readable storage media of claim 14, wherein a game asset of the game assets is loaded into the cache memory before the other game assets, wherein the game asset is used for presenting content in the wagering game that has been unlocked by the wagering game player during play of the online nonwagering game.

16. The one or more machine-readable storage media of claim 13, wherein the load order is based on a history of play of the wagering game by a defined group of wagering game players relative to a time for a location of the wagering game machine.

17. The one or more machine-readable storage media of claim 13, wherein the load order is based on a probability of activating a bonus game of the wagering game.

18. An apparatus comprising:
at least one display device;
at least one processor;
at least one memory device that includes a cache memory and a nonvolatile machine-readable medium, the at least one memory device configured to store instructions that, when executed by the at least one processor, cause the apparatus to:
retrieve a default load order for loading game assets into the cache memory of the apparatus from the nonvolatile machine-readable medium that is within at least one of the apparatus and a remote device that is communicatively coupled to the apparatus, wherein the game assets comprise data accessed for presentation of a wagering game at the apparatus, wherein the game assets are accessed by the at least one processor from the cache memory for presentation of the wagering game;
modify the default load order to create a modified load order for loading the game assets into the cache memory, wherein the modified load order is based on an identification of a wagering game player playing the wagering game;
load the game assets into the cache memory from the nonvolatile machine-readable medium based on the modified load order;
access, by the processor, the game assets from the cache memory;
present the wagering game based on the game assets; and
unload at least one game asset of the game assets stored in the cache memory based on play of the wagering game, wherein the at least one game asset unloaded was accessed for display of a part of the wagering game that has already been played by the wagering game player.

19. The apparatus of claim 18, wherein a different game asset is only loaded on demand into the cache memory in response to the different game asset exceeding a size threshold and in response to a probability of the different game asset being accessed by the process being below an access threshold.

20. The apparatus of claim 18, wherein a multiple of game assets of the game assets are bundled together for being loaded into the cache memory, wherein the multiple of game assets are bundled based on being accessed by the processor at or near a same time.

21. The apparatus of claim 18, wherein the load order is base on a history of play of the wagering game by the wagering game player, wherein a game asset for presenting content of the wagering game that has a probability that is below a threshold for being presented based on the history of play of the wagering game by the wagering game player is at least one of
loaded only on demand into the cache memory; and
positioned at an end of the load order.

22. An apparatus comprising:
means for determining a load order for loading game assets into a cache memory of a wagering game machine, wherein the game assets comprise data used for presentation of a wagering game at the wagering game machine, the game assets accessible by a processor in the wagering game machine from the cache memory for presentation of the wagering game, wherein the load order is based on wagering game activity at the wagering game machine;
means for loading the game assets into the cache memory based on the load order;
means for accessing, by a processor in the wagering game machine, the game assets from the cache memory; and
means for presenting the wagering game based on the game assets.

23. The apparatus of claim 22, wherein the wagering game activity comprises at least one of probability of wins from play of the wagering game and an identification of a wagering game player playing the wagering game.

24. The apparatus of claim 23, wherein the load order is based on play by the wagering game player of an online nonwagering game having a same theme as a theme of the wagering game.

25. The apparatus of claim 24, wherein a game asset of the game assets is loaded into the cache memory before the other game assets, wherein the game asset is used for presenting content in the wagering game that has been unlocked by the wagering game player during play of the online nonwagering game.
